(19) United States
(12) Patent Application Publication
(10) Pub. No.: US 2010/0117999 A1
(43) Pub. Date: May 13, 2010

(54) ORGANIC ELECTROLUMINESCENT DISPLAY DEVICE

(76) Inventors: Atsushi Matsunaga, Kanagawa (JP); Masaya Nakayama, Kanagawa (JP); Atsushi Tanaka, Kanagawa (JP)

Correspondence Address: BIRCH STEWART KOLASCH & BIRCH, PO BOX 747, FALLS CHURCH, VA, 22040-0747, US

(21) Appl. No.: 12/594,532

(22) PCT Filed: Apr. 3, 2008
(86) PCT No.: PCT/JP2008/057054

§ 371 Date: Oct. 2, 2009

(51) Int. Cl. G09G 5/00

(52) U.S. Cl. 345/204; 345/80; 345/32

(57) ABSTRACT

An organic electroluminescent display device includes at least a driving TFT and pixels which are formed by organic electroluminescent elements and are provided on a substrate of the TFT. The driving TFT includes at least a substrate, a gate electrode, a gate insulating film, an active layer, a source electrode, and a drain electrode. The driving TFT further includes a resistive layer between the active layer and at least one of the source electrode and the drain electrode. The pixels include at least one color-modified pixel which has a color filter that modifies the emission color of the color-modified pixel, and which emits light of the modified color.

### TECHNICAL FIELD

The present invention relates to an organic electroluminescent display device having an organic electroluminescent element and a TFT (thin film transistor), in particular to an organic electroluminescent display device having an improved TFT in which an amorphous oxide semiconductor is used and a color-filter-based color-emitting organic electroluminescent element. In the present invention, the TFT refers to a field-effect TFT unless otherwise indicated.

### BACKGROUND ART

In recent years, flat thin image-display devices (flat panel displays: FPD) have been put into practical use along with advance in technology in liquid crystal and electroluminescence (EL). In particular, organic electroluminescent elements (hereinafter referred to as “organic El elements” in some cases), which use thin-layer materials that are excited by electric current to emit light, can emit light of high luminance with a low voltage, and are expected to realize reduction in the thickness, weight, size, and power consumption of the devices in wide range of fields, including cell phone displays, personal digital assistants (PDA), computer displays, information displays to be mounted on automobiles, TV monitors, and general illumination.

Systems for achieving a full color organic electroluminescent display device are, for example, an RGB independent emission system in which organic luminescent layers emitting red light, green light, and blue light, respectively, are provided independently on a substrate, a color conversion system having a separate color conversion layer, and a color filter system in which separate color filters for R, G, and B, respectively, are provided to an organic luminescent layer emitting white light.

The RGB independent emission system requires deposition and patterning of RGB materials using shadow masks. In contrast, the color filter system has an advantage in that a relatively high definition display panel can be obtained easily since color filters can be provided by existing photolithography methods (see, for example, Japanese Patent Application Laid-Open (JP-A) Nos. 7-220871 and 2004-311440).

However, in the color filter system, the white light emitted from the organic EL element is attenuated during the course of passing through the color filter, so that reduction of luminance is inevitable. Therefore a material emitting high-luminance white light at a high efficiency is necessary for obtaining a high-luminance display device. However, the total efficiency is still low in comparison with the RGB independent emission system.

These FPDs are driven by active matrix circuits of TFTs, in which an amorphous silicon thin film or a polycrystalline silicon thin film provided on a glass substrate is used as an active layer.

Recently, the development of TFTs having semiconductor thin films made of amorphous oxides (e.g., In—Ga—Zn—O type amorphous oxide) has been conducted actively (see, for example, JP-A No. 2006-165529). The TFTs in which amorphous oxide semiconductors are used are capable of film formation at room temperature, and can be formed on films. Therefore the amorphous oxide semiconductors as materials for the active layers of film (flexible) TFTs have attracted attention recently. In particular, it has been reported by Hosono et al. of Tokyo Institute of Technology that TFTs using a-IGZO achieved a field-effect mobility of about 10 cm²/Vs even on a PEN substrate, which was higher than the mobility achieved by a-Si type TFTs on glass substrates; thus the TFTs using a-IGZO have attracted attention as film TFTs in particular (see, for example, Nature vol. 432 (25 Nov., 2004) pp. 488-492).

When the TFTs using a-IGZO are used as driving circuits of display devices for example, there are problems in that the mobility of 1 to 10 cm²/Vs is insufficient for supplying an adequate electric current, the OFF current is large, and ON/OFF ratio is low. Therefore further improvements in the mobility and the ON/OFF ratio have been required for use in driving high definition organic EL elements.

Further, driving TFTs that can control high electric current have been desired in order to achieve high luminance in color-filter-based full-color organic electroluminescent display devices.

### DISCLOSURE OF THE INVENTION

### Problem to Be Solved by the Invention

An object of the present invention is to provide an organic electroluminescent display device (hereinafter referred to as “organic EL display device” in some cases) equipped with a TFT having a high field-effect mobility and a high ON/OFF ratio, in particular a color-filter-based color emitting organic EL display device.

### Means to Solve the Problem

The above object of the present invention is achieved by the following measures: A first aspect of the present invention provides an organic electroluminescent display device comprising at least a driving TFT and pixels which are formed by organic electroluminescent elements and are provided on a substrate of the TFT,

wherein the driving TFT includes at least a substrate, a gate electrode, a gate insulating film, an active layer, a source electrode, and a drain electrode; the driving TFT further includes a resistive layer between the active layer and at least one of the source electrode and the drain electrode; and the pixels include at least one color-modified pixel which has a color filter that modifies the emission color of the color-modified pixel, and which emits light of the modified color.

A second aspect of the invention provides an organic electroluminescent display device as described in the first aspect, wherein the resistive layer has a lower electrical conductivity than that of the active layer.

A third aspect of the invention provides an organic electroluminescent display device as described in the first or second aspect, wherein, in the at least one color-modified pixel, the color filter is provided at the side of the luminescent layer of the organic electroluminescent element from which light is extracted.

A fourth aspect of the invention provides an organic electroluminescent display device as described in any one of the first to third aspects, wherein the pixels include two or more kinds of pixel having respectively different emission colors, and at least one of the pixels is the at least one color-modified pixel.

A fifth aspect of the invention provides an organic electroluminescent display device as described in the fourth aspect, wherein the two or more kinds of pixel having different emission colors include a red emitting pixel, a green emitting pixel, and a blue emitting pixel.

A sixth aspect of the invention provides an organic electroluminescent display device as described in the fourth or fifth aspect, wherein the two or more kinds of pixel having respectively different emission colors include a white emitting pixel, a red emitting pixel, a green emitting pixel, and a blue emitting pixel.

A seventh aspect of the invention provides an organic electroluminescent display device as described in the sixth aspect, wherein each of the red emitting pixel, the green emitting pixel, and the blue emitting pixel is a pixel in which the emission color of the white emitting pixel is modified by a color filter.

An eighth aspect of the invention provides an organic electroluminescent display device as described in any one of the first to seventh aspects, wherein the active layer is in contact with the gate insulating film, and the resistive layer is in contact with at least one of the source electrode and the drain electrode.

An ninth aspect of the invention provides an organic electroluminescent display device as described in any one of the first to eighth aspects, wherein the thickness of the resistive layer is greater than the thickness of the active layer.

A tenth aspect of the invention provides an organic electroluminescent display device as described in any one of the first to eighth aspects, wherein electrical conductivity continuously varies between the resistive layer and the active layer.

An eleventh aspect of the invention provides an organic electroluminescent display device as described in any one of the first to tenth aspects, wherein the active layer and the resistive layer include oxide semiconductors, which may be the same or different.

A twelfth aspect of the invention provides an organic electroluminescent display device as described in the eleventh aspect, wherein the oxide semiconductor is an amorphous oxide semiconductor.

A thirteenth aspect of the invention provides an organic electroluminescent display device as described in the eleventh or twelfth aspect, wherein the oxygen concentration in the active layer is lower than the oxygen concentration in the resistive layer.

A fourteenth aspect of the invention provides an organic electroluminescent display device as described in any one of the eleventh to thirteenth aspects, wherein the oxide semiconductor is at least one selected from the group consisting of oxides of In, Ga, and Zn, or a composite oxide thereof.

A fifteenth aspect of the invention provides an organic electroluminescent display device as described in the fourteenth aspect, wherein the oxide semiconductor includes In and Zn, and the composition ratio of Zn to In (Zn/In) in the resistive layer is higher than that in the active layer.

A sixteenth aspect of the invention provides an organic electroluminescent display device as described in any one of the first to fifteenth aspects, wherein the electrical conductivity of the active layer is 10⁴ Scm⁻¹ or more but less than 10² Scm⁻¹.

A seventeenth aspect of the invention provides an organic electroluminescent display device as described in any one of the first to sixteenth aspects, wherein the ratio of the electrical conductivity of the active layer to the electrical conductivity of the resistive layer (electrical conductivity of the resistive layer/electrical conductivity of the active layer) is from 10² to 10⁸.

An eighteenth aspect of the invention provides an organic electroluminescent display device as described in any one of the first to seventeenth aspects, wherein the substrate is a flexible resin substrate.

### EFFECTS OF THE INVENTION

According to the present invention, an organic EL display device can be provided having a TFT in which a semiconductor with a high field-effect mobility, a high ON/OFF ratio, and capability to control a high electric current is used. In particular, a color-filter-based color emitting high-luminance organic EL display device can be provided.

### BRIEF DESCRIPTION OF THE DRAWINGS

FIG. 1 is a conceptual diagram showing a constitution of a driving TFT and an organic EL element in an organic EL display device according to the present invention.

FIG. 2 is a conceptual diagram showing a constitution of a TFT according to the present invention.

FIG. 3 is a conceptual diagram showing a constitution of a top-gate type TFT according to the present invention.

### BEST MODE FOR CARRYING OUT THE INVENTION

### 1. Thin Filter Transistor (TFT)

The TFT according to the invention is an active element including at least a gate electrode, a gate insulating film, an active layer, a source electrode, and a drain electrode, and having a function of applying a voltage to the gate electrode so as to control the electric current flowing into the active layer and so as to switch the electric current between the source electrode and the drain electrode. The TFT structure may be either a staggered structure or an inversely-staggered structure.

In the present invention, a resistive layer is disposed between, and electrically connects, the active layer and at least one of the source electrode or the drain electrode. The electrical conductivity of the resistive layer is preferably lower than the electrical conductivity of the active layer.

In a preferable exemplary embodiment, at least the resistive layer and the active layer are provided, in layers, on the substrate, the active layer is in contact with the gate insulating film, and the resistive layer is in contact with at least one of the source electrode and the drain electrode.

The electrical conductivity of the active layer is preferably 10⁻⁴ Scm⁻¹ or more but less than 10² Scm⁻¹, more preferably 10⁻¹ Scm⁻¹ or more but less than 10² Scm⁻¹. The electrical conductivity of the resistive layer is preferably 10⁻² Scm⁻¹ or less, more preferably from 10⁻⁹ Scm⁻¹ or more but less than 10⁻³ Scm⁻¹, and is lower than the electrical conductivity of the active layer. More preferably, the ratio of the electrical conductivity of the active layer to the electrical conductivity of the resistive layer (the electrical conductivity of the active layer/the electrical conductivity of the resistive layer) is in the range of from 10² to 10⁸.

A high field-effect mobility may not be obtained when the electrical conductivity of the active layer is lower than 10⁻⁴ Scm⁻¹, whereas an excellent ON/OFF ratio may not be obtained when the electrical conductivity of the active layer is 10²Scm⁻¹ or more due to an increase in the OFF current, which is not preferable.

The thickness of the resistive layer is preferably greater than the thickness of the active layer, from the viewpoint of operation stability.

More preferably, the ratio of the thickness of the resistive layer to the thickness of the active layer (the thickness of the resistive layer/the thickness of the active layer) is more than 1 but 100 or less, and is still more preferably more than 1 but 10 or less.

It is also preferable that electrical conductivity continuously varies between the resistive layer and the active layer.

Preferably, the active layer and/or the resistive layer includes an oxide semiconductor from the viewpoint of capability of low-temperature film formation. In particular, the oxide semiconductor is more preferably in an amorphous state. When the active layer and the resistive layer both include oxide semiconductors, the oxide semiconductors may be the same or different.

The oxygen concentration in the active layer is preferably lower than the oxygen concentration of the resistive layer.

The oxide semiconductor preferably includes at least one selected from the group consisting of In, Ga, and Zn, or a composite oxide thereof. The oxide semiconductor more preferably includes In and Zn, and the composition ratio of Zn to In (Zn/In) in the resistive layer is preferably higher than that in the active layer. The composition ratio of Zn to In (Zn/In) in the resistive layer is preferably higher than that in the active layer by at least 3%, and more preferably, by at least 10%.

The substrate is preferably a flexible resin substrate.

1) Structure

Next, a constitution of a TFT used in the present invention will be described.

FIG. 2 is a schematic diagram showing one example of a TFT with an inversely staggered structure according to the present invention. When a substrate 51 is a flexible substrate such as a plastic film, an insulating layer 56 is provided on one surface of the substrate 51, and a gate electrode 52, a gate insulating film 53, a active layer 54-1, a resistive layer 54-2 are layered thereon, and a source electrode 55-1 and a drain electrode 55-2 are further provided on a surface thereof. The active layer 54-1 is in contact with the gate insulating film 53, and the resistive layer 54-2 is in contact with the source electrode 55-1 and the drain electrode 55-2. The compositions of the active layer and the resistive layer are determined such that the electrical conductivity of the active layer is higher than the electrical conductivity of the resistive layer when a voltage is not applied to the gate electrode. The active layer and the resistive layer include oxide semiconductors which may be the same or different, and the oxide semiconductors are selected from those disclosed in JP-A No. 2006-165529, for example, an In—Ga—Zn—O type oxide semiconductor. These oxide semiconductors are known to show a higher electron mobility when the electron carrier concentration is higher. In other words, a higher electrical conductivity leads to higher electron mobility.

In the structure according to the present invention, a high ON electric current realizes when the TFT is takes the ON-state under application of a voltage to the gate electrode to form a channel; this is because the field-effect mobility of the TFT is high due to a high electrical conductivity of the active layer serving as the channel. In the OFF-state in which a voltage is not applied to the gate electrode and the channel is not formed, the ON/OFF ratio characteristics are significantly improved by the presence of the intervening resistive layer having a high electric resistance which maintains the OFF current low.

The TFT structure according to the present invention features a semiconductor layer in which the electrical conductivity of the semiconductor layer in the vicinity of the gate insulating film is higher than the electrical conductivity of the semiconductor layer in the vicinity of the source electrode and the drain electrode. The term “semiconductor layer” used herein refers to a layer including the active layer and the resistive layer. As long as the state is realized, means for achieving the state is not limited to providing a semiconductor layer having two layers shown in FIG. 2. The structure may alternatively have a multi-layer structure having three or more layers, or the electrical conductivity may vary continuously.

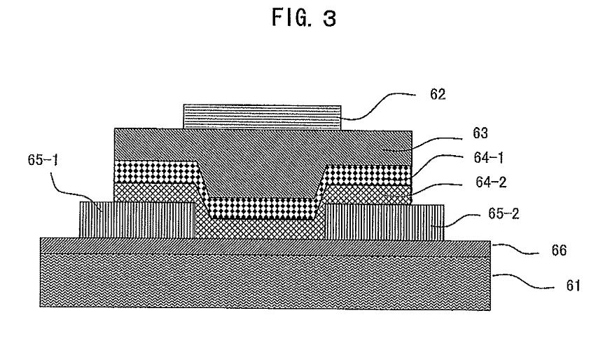

FIG. 3 is a schematic diagram showing one example of a TFT having a top gate structure according to the present invention. When a substrate 61 is a flexible substrate such as a plastic film, an insulating layer 66 is provided on one surface of the substrate 61, a source electrode 65-1 and a drain electrode 65-2 are provided on the insulating layer, a resistive layer 64-2 and a active layer 64-1 are further layered thereon, and a gate insulating film 63 and a gate electrode 62 are further provided thereon. Similarly to the inversely staggered structure, the active layer (high electrical conductivity layer) is in contact with the gate insulating film 63, and the resistive layer (low electrical conductivity layer) is in contact with the source electrode 65-1 and the drain electrode 65-2. The compositions of the active layer 64-1 and the resistive layer 64-2 are determined such that the electrical conductivity of the active layer 64-1 is higher than the electrical conductivity of the resistive layer 64-2 when a voltage is not applied to the gate electrode 62.

2) Electrical Conductivity

The electrical conductivity of the active layer and the resistive layer according to the invention will be described.

An electrical conductivity is a characteristic value that indicates easiness of electric conduction through a substance, and is represented by the following formula:

σ=neμ,

wherein n represents the carrier concentration of the substance, μ represents the carrier mobility, σ represents the electrical conductivity of the substance, and e represents the elementary electric charge. When the active layer or the resistive layer is an n-type semiconductor, the carrier is electrons, the carrier concentration refers to the electron carrier concentration, and the carrier mobility refers to the electron mobility. Similarly, when the active layer or the resistive layer is a p-type semiconductor, the carrier is holes, the carrier concentration refers to the hole carrier concentration, and the carrier mobility refers to the hole mobility. The carrier concentration and the carrier mobility of a substance can be obtained by a measurement of holes.

<Method for Obtaining Electrical Conductivity>

By measuring the sheet resistance of a film whose thickness has already been determined, the electrical conductivity of the film can be obtained. Although the electrical conductivity of the semiconductor varies with temperature, the electrical conductivity mentioned herein refers to an electrical conductivity at room temperature (20° C.).

3) Gate Insulating Film

The gate insulating film may include an insulating substance such as SiO₂, SiNₓ, SiON, Al₂O₃, Y_{S}O₃, Ta₂O₅, or HfO₂, or a mixed crystal compound containing at least two selected from these compounds. A macromolecular insulating material such as polyimide may also be used as the gate insulating film

The thickness of the gate insulating film is preferably from 10 nm to 10 μm. The gate insulating film should have a substantial thickness in order to reduce a leak current and increase voltage resistance. However, an increase in the thickness of the gate insulating film results in an increase in the TFT driving voltage. Therefore, the thickness of the gate insulating film is more preferably from 50 nm to 1000 nm in the case of an inorganic insulating material, and is more preferably from 0.5 μm to 5 μm in the case of a macromolecular insulating material. In particular, when an insulating material with a high dielectric constant, such as HfO₂, is used in the gate insulating layer, TFT may be driven at voltage even with an increased film thickness, which is preferable.

4) Active Layer and Resistive Layer

The active layer and the resistive layer to be used in the invention preferably include oxide semiconductors. The oxide semiconductors are more preferably amorphous oxide semiconductors. Oxide semiconductors, in particular amorphous oxide semiconductors, can be formed on a flexible resin substrate such as plastic, due to its ability to form a film at low temperature. Preferable examples of amorphous oxide semiconductors that can be formed at low temperature include oxides each containing In, oxides each containing In and Zn, and oxides each containing In, Ga, and Zn, as described in JP-A No. 2006-165529. It is known that the composition structure thereof is preferably InGaO₃(ZnO)ₘ wherein m represents a natural number less than 6. These oxides are n-type semiconductors in which the carrier is electrons. Of course, the active layer and the resistive layer may alternatively include p-type oxide semiconductors, such as ZnO—Rh₂O₃, CuGaO₂, or SrCu₂O₂.

Specifically, the amorphous oxide semiconductor according to the invention is preferably an amorphous oxide semiconductor including In—Ga—Zn—O and having a composition of InGaO₃(ZnO)ₘ (in representing a natural number less than 6) in the crystalline state. In particular, InGaZnO₄ is more preferable. An amorphous oxide semiconductor having the composition characteristically has a tendency to show an increased electron mobility as the electrical conductivity increases. It has been disclosed in JP-A No. 2006-165529 that the electrical conductivity can be adjusted by adjusting an oxygen partial pressure during film formation.

Of course, the materials of the active layer and the resistive layer are not limited to oxide semiconductors, and inorganic semiconductors such as Si and Ge, compound semiconductors such as GaAs, and organic semiconductors such as pentacene and polythiophene are also usable in the active layer and/or the resistive layer.

<Electrical Conductivity of Active Layer and Resistive Layer>

The electrical conductivity of the active layer according to the invention is characteristically higher than that of the resistive layer.

The ratio of the electrical conductivity of the active layer to the electrical conductivity of the resistive layer (the electrical conductivity of the active layer/the electrical conductivity of the resistive layer) is preferably from 10¹ to 10¹⁰, more preferably from 10² to 10⁸. The electrical conductivity of the active layer is preferably from 10⁻⁴ Scm⁻¹ or more but less than 10² Scm⁻¹, more preferably from 10⁻¹ Scm⁻¹ or more but less than 10² Scm⁻¹.

The electrical conductivity of the resistive layer is preferably 10⁻² Scm⁻¹ or less, and more preferably from 10⁻⁹ Scm⁻¹ to 10⁻³ Scm⁻¹.

<Thicknesses of Active Layer and Resistive Layer>

The thickness of the resistive layer is preferably greater than the thickness of the active layer. It is more preferable that the ratio of the thickness of the resistive layer to the thickness of the active layer (thickness of the resistive layer/thickness of the active layer) is more than 1 but 100 or less, and it is still more preferable that the ratio is more than 1 but 10 or less.

The thickness of the active layer is preferably from 1 nm to 100 nm, and more preferably from 2.5 nm to 30 nm. The thickness of the resistive layer is preferably from 5 nm to 500 nm, and more preferably from 10 nm to 100 nm.

A TFT characteristics with an ON/OFF ratio of 10⁶ or more can be achieved in a TFT having a high mobility of 10 cm²/(Vsec) or more by using an active layer and a resistive layer having the above constitutions.

<Methods for Adjusting Electrical Conductivity>

The following measures may be mentioned as methods for adjusting electrical conductivity when the active layer and the resistive layers are oxide semiconductors.

### (1) Adjustment by Oxygen Defects

It is known that, when oxygen defects occur in an oxide semiconductor, carrier electrons are generated to increase the electrical conductivity. Therefore it is possible to adjust the electrical conductivity of the oxide semiconductor by adjusting the amount of oxygen defects. Specific methods for adjusting the oxygen defects amount may include adjustment of at least one of the oxygen partial pressure during film formation, the oxygen concentration during a post-treatment after film formation and the processing time of the post-treatment. Examples of the post-treatment include, specifically, a thermal treatment at 100° C. or higher, an oxygen plasma, and a UV ozone treatment. Among these methods, a method of adjusting the oxygen partial pressure during film formation is preferable from the viewpoint of productivity. JP-A No. 2006-165529 discloses that the electrical conductivity of an oxide semiconductor can be adjusted by adjusting the oxygen partial pressure during film formation, and this technique may be utilized.

### (2) Adjustment by Composition Ratio

It has been known that the electrical conductivity can be changed by changing the metal composition ratio of an oxide semiconductor. For example, it is disclosed in JP-A No. 2006-165529 that an increased proportion of Mg in InGaZn₁₋ₓMgₓO₄ leads to a decrease in electrical conductivity. Further, it has been reported that, in an oxide system of (In₂O₃)₁₋ₓ(ZnO)ₓ, an increase in Zn proportion leads to a decrease in electrical conductivity if the Zn/In ratio is 10% or higher (see “Toumei Doudennmakuno Shintennkai II” (New Development of transparent conductive film) (CMC Publishing Co., Ltd.) pp. 34 to 35). A specific method for changing the composition ratio may be, for example in a film formation by sputtering, use of a target selected from various targets of different composition ratios. Alternatively, multiple targets may be co-sputtered, and the sputtering rates of the targets may be individually controlled to change the composition ratio of the film.

### (3) Adjustment by Impurity

It is disclosed in JP-A No. 2006-165529 that the electron carrier concentration can be reduced (i.e., the electrical conductivity can be reduced) by adding to an oxide semiconductor one or more elements such as Li, Na, Mn, Ni, Pd, Cu, Cd, C, N, or P as impurity. Examples of methods for adding the impurity include co-deposition of the oxide semiconductor and the impurity element(s), and an ion doping method of doping a produced oxide semiconductor film with ions of the impurity element(s).

### (4) Adjustment by Oxide Semiconductor Material

In the above items (1) to (3), methods for adjusting electrical conductivity within the same oxide semiconductor series are described. However, as a matter of course, the electrical conductivity can be changed also by changing the oxide semiconductor material. For example, SnO₂-based oxide semiconductors are known to generally have a lower electrical conductivity than In₂O₃-based oxide semiconductors. Accordingly, the electrical conductivity can be adjusted by changing the oxide semiconductor material. As oxide materials having particularly small electrical conductivities, oxide insulating materials such as Al₂O₃, Ga₂O₃, ZrO₂, Y₂O₃, Ta₂O₃, MgO, or HfO₃ are known, and are usable in the invention.

For adjusting the electrical conductivity, only one of the methods described in (1) to (4) may be used singly, or a combination of some or all of the methods described in (1) to (4) may be used.

<Method for Forming Active Layer and Resistive Layer>

Methods for forming the active layer and the resistive layer are preferably vapor-phase film forming methods using polycrystalline sintered bodies of oxide semiconductors as targets. Among vapor-phase film forming methods, a sputtering method and a pulse laser deposition method (PLD method) are suitable. Further, the sputtering method is preferable from the viewpoint of mass production.

For example, a film can be formed by an RF magnetron sputtering deposition method under controlled vacuum degree and oxygen flow rate. A lower electrical conductivity can be obtained at a larger oxygen flow rate.

The film that has been formed can be confirmed to be an amorphous film by a well-known X-ray diffraction method. The thickness of the film can be determined by a measurement with a stylus-type surface profilometer. The composition ratio can be obtained by a RBS (Rutherford back scattering) analysis method.

5) Gate Electrode

The gate electrode in the present invention is preferably, for example, a metal such as Al, Mo, Cr, Ta, Ti, Au, or Ag, an alloy such as Al—Nd or APC, a metal oxide conductor film such as tin oxide, zinc oxide, indium oxide, indium tin oxide (ITO), or an indium zinc oxide (IZO), an organic conductive compound such as polyaniline, polythiophene, or polypyrrole, or a mixture thereof.

The thickness of the gate electrode is preferably from 10 nm to 1000 nm.

Methods for forming an electrode film are not particularly limited, and the electrode may be formed on the substrate by a method selected appropriately from, for example, wet methods such as printing methods and coating methods, physical methods such as vacuum deposition methods, sputtering methods, and ion plating methods, and chemical methods such as CVD and plasma CVD methods, in consideration of compatibility with the aforementioned material. For example, when ITO is selected, an electrode can be provided by, for example, a DC or radio-frequency sputtering method, a vacuum deposition method, or an ion plating method. When an organic conductive compound is selected as the material for the gate electrode, an electrode can be formed by a wet-system film forming method.

6) Source Electrode and Drain Electrode

Materials for the source electrode and the drain electrode in the invention are preferably selected from, for example, metals such as Al, Mo, Cr, Ta, Ti, Au, and Ag, alloys such as Al—Nd and APC, metal oxide conductive films such as of tin oxide, zinc oxide, indium oxide, indium tin oxide (ITO), and indium zinc oxide (IZO), organic conductive compounds such as polyaniline, polythiophene and polypyrrole, and mixtures thereof.

The thicknesses of the source electrode and the drain electrode are each preferably from 10 nm to 1000 nm.

Methods for forming an electrode film are not particularly limited, and the electrode may be formed on the substrate by a method selected appropriately from, for example, wet methods such as printing methods and coating methods, physical methods such as vacuum deposition methods, sputtering methods, and ion plating methods, and chemical methods such as CVD and plasma CVD methods, in consideration of compatibility with the aforementioned material. For example, when ITO is selected, an electrode can be provided by, for example, a DC or radio-frequency sputtering method, a vacuum deposition method, or an ion plating method. When an organic conductive compound is selected as the material for the source electrode and the drain electrode, an electrode can be formed by a wet-system film forming method.

7) Substrate

The substrate to be used in the present invention is not particularly limited, and examples thereof include inorganic materials such as YSZ (yttria-stabilized zirconia) and glass, and organic materials such as polyesters (e.g., polyethylene terephthalate, polybutylene terephthalate, and polyethylene naphthalate) and synthetic resins (e.g., polystyrene, polycarbonate, polyethersulfone, polyarylate, allyldiglycolcarbonate, polyimide, polycycloolefin, norbornene resins, and poly(chlorotrifluoroethylene). When the substrate includes an organic material such as those described above, the organic material is preferably excellent in heat resistance, dimensional stability, solvent resistance, electric insulating property, and processability, and preferably low in gas permeation and hygroscopicity.

In the present invention, a flexible substrate is preferably used in particular. As materials to be used in the flexible substrate, organic plastic films having high transparency are preferable, and examples of usable plastic films include plastic films of polyesters such as polyethylene terephthalate, polybutylene phthalate, and polyethylene naphthalate, polystyrene, polycarbonate, polyethersulfone, polyarylate, polyimide, polycycloolefin, norbornene resins, and poly(chlorotrifluoroethylene). The film-shaped plastic substrate is preferably provided with one or more additional layers such as an insulating layer that may be provided when the insulating property of the substrate is insufficient, a gas barrier layer for preventing permeation of moisture and oxygen, and an undercoat layer for improving the planarity of the film-shaped plastic substrate and adhesion to the electrode and/or the active layer.

The thickness of the flexible substrate is preferably from 50 μm to 500 μm. This is because, when the thickness of the flexible substrate is less than 50 μm, it is difficult for the substrate itself to maintain sufficient planarity. When the thickness of the flexible substrate is larger than 500 μm, it is difficult to freely bend the substrate; in other words, the flexibility of the substrate itself is poor.

8) Protective Insulating Film

A protective insulating film may be provided on the TFT as necessary. The protective insulating film is used for protecting the semiconductor layer (the active layer and the resistive layer) from deterioration caused by air, and/or for insulating the TFT from an electronic device to be produced on the TFT.

Specific examples of protective insulating film materials include metal oxides such as MgO, SiO, SiO₂, Al₂O₃, GeO, NiO, CaO, BaO, Fe₂O₃, Y₂O₃, and TiO₂, metal nitrides such as SiNₓ and SiNₓO_{y}, metal fluorides such as MgF₂, LiF, AlF₃, and CaF₂, polyethylene, polypropylene, polymethyl methacrylate, polyimide, polyurea, polytetrafluoroethylene, polychlorotrifluoroethylene, polydichlorodifluoroethylene, copolymers of chlorotrifluoroethylene and dichlorodifluoroethylene, copolymers obtained by copolymerization of a mixture of monomers including tetrafluoroethylene and at least one comonomer, fluorine-containing copolymers each having a cyclic structure in the copolymer main chain, water absorbing substances having a water absorption coefficient of 1% or more, and dampproof substances having a water absorption coefficient of 0.1% or less.

Methods for forming the protective insulating film are not particularly limited, and the following methods are applicable: a vacuum deposition method, a sputtering method, a reactive sputtering method, an MBE (molecular beam epitaxy) method, a cluster ion beam method, an ion plating method, a plasma polymerization method (radio-frequency exciting ion plating method), a plasma CVD method, a laser CVD method, a heat CVD method, a gas source CVD method, a coating method, a printing method, and a transfer method.

9) Post-Treatment

A thermal treatment may be conducted as a post-treatment on the TFT, as necessary. The thermal treatment may be conducted at a temperature of 100° C. or more in the air or in a nitrogen atmosphere. The thermal treatment may be conducted after forming the semiconductor layer and/or as a final step in the TFT production process. The thermal treatment is effective in, for example, suppression of in-plane unevenness of the TFT characteristices and an improvement of the driving stability.

### 2. Organic EL Element

The organic EL element according to the present invention has a cathode and an anode on a substrate, and further has one or more organic compound layers, including an organic luminescent layer (hereinafter simply referred to as “luminescent layer” in some cases), between the electrodes. In view of the characteristics of the luminescent element, at least one electrode selected from the anode and the cathode is preferably transparent.

Regarding the lamination of the organic compound layers in the present invention, an embodiment is preferable in which a hole transport layer, a luminescent layer, and an electron transport layer are provided in this order from the anode side. Further, a charge blocking layer or the like may be provided between the hole transport layer and the luminescent layer, or between the luminescent layer and the electron transport layer. There may be a hole injection layer between the anode and the hole transport layer, and there may be an electron injection layer between the cathode and the electron transport layer. Each layer may include plural sub-layers.

In the following, components constituting the luminescent material according to the present invention will be described in detail.

<Substrate>

The substrate to be used in the present invention is preferably a substrate that does not scatter or attenuate the light emitted from the organic compound layers. Examples thereof include inorganic materials such as yttria-stabilized zirconia (YSZ) and glass, polyesters such as polyethylene terephthalate, polybutylene phthalate, and polyethylene naphthalate, polystyrene, polycarbonate, polyethersulfone, polyarylate, polyimide, polycycloolefin, norbornene resins, and poly(chlorotrifluoroethylene).

For example, when glass is used as the substrate, the glass material is preferably a non-alkaline glass in consideration of reduction of eluted ions from glass. When a soda-lime glass is used, it is preferable to use one which has been barrier-coated with silica or the like. When the substrate is an organic material, the material is preferably excellent in heat resistance, dimensional stability, solvent resistance, electric insulating property, and processability.

The shape, structure, and size of the substrate are not particularly limited, and may be appropriately selected in accordance with the use, purpose, and the like of the luminescent element. In general, the substrate is preferably plate-shaped. The structure of the substrate may be a single-layer structure, or a multi-layer structure, and may be constituted by only one member or by two or more members.

The substrate may be colorless transparent, or colored transparent. However, a colorless transparent substrate is preferable since the light emitted from the organic luminescent layer is not scattered or attenuated.

A moisture blocking layer (gas barrier layer) may be provided on the front or back surface of the substrate. The material of the moisture blocking layer (gas barrier layer) is preferably an inorganic material such as silicon nitride or silicon oxide. The moisture blocking layer (gas barrier layer) may be formed by, for example, a radio-frequency sputtering method.

When a thermoplastic substrate is used, one or more additional layers such as a hardcoat layer or an undercoat layer may be provided in accordance with necessity.

<Anode>

The anode generally has a function as an electrode that supplies holes to an organic compound layer. The shape, structure, and size thereof are not particularly limited, and may be appropriately selected from known electrode materials in accordance with the use and purpose of the luminescent element. As described above, the anode is usually provided as a transparent anode.

The material of the anode is preferably, for example, a metal, an alloy, a metal oxide, an electrically conductive compound, or a mixture thereof. Specific examples of the anode material include conductive metal oxides such as tin oxides doped with antimony, fluorine, or the like (ATO, FTO), tin oxide, zinc oxide, indium oxide, indium tin oxide (ITO), and indium zinc oxide (IZO), metals such as gold, silver, chromium, and nickel, mixtures and laminates of any of such metals and a conductive metal oxide, inorganic conductive materials such as copper iodide and copper sulfide, organic conductive materials such as polyaniline, polythiophene, and polypyrrole, and laminates of any of such materials and ITO. Among them, a conductive metal oxide is preferable, and ITO is more preferable from the viewpoints of, in particular, productivity, high electrical conductivity, and transparency.

The anode may be formed on the substrate by a method that is appropriately selected from, for example, the following methods in consideration of the compatibility with the material for constituting the anode: wet systems such as printing systems and coating systems, physical systems such as vacuum deposition methods, sputtering methods, and ion plating methods, and chemical methods such as CVD and plasma CVD methods. For example, when ITO is selected as the material of the anode, the anode may be formed by a DC or radio-frequency sputtering method, a vacuum deposition method, or an ion plating method.

In the organic electroluminescent element according to the invention, the position at which the anode is provided is not particularly limited, and may be selected appropriately in accordance with the use and purpose of the luminescent element. The anode is preferably formed on the substrate; in this case, the anode may be provided on the whole of one surface of the substrate, or on only a part of the one surface of the substrate.

The patterning at the time of forming the anode may be conducted by a chemical etching such as photolithography, or by a physical etching such as etching with a laser. The patterning may be effected by vacuum deposition, sputtering, or the like with a mask being superposed, or by a lift-off method or a printing method.

The thickness of the anode may be adequately selected in accordance with the material constituting the anode, and thus cannot be defined uniquely. The thickness of the anode is generally from about 10 nm to about 50 μm, preferably from 50 nm to 20 μm.

The electric resistance of the anode is preferably 10³ Ω/sq or less, more preferably 10² Ω/sq or less. When the anode is transparent, the anode may be colorless transparent or colored transparent. In order to extract emitted light from the transparent anode side, the transmittance of the anode is preferably 60% or more, and more preferably 70% or more.

Transparent anodes are described in detail in Yutaka Sawada ed. “Toumei Denkyokumakuno Shintenkai” (New Development of Transparent Electrode Film) (CMC Publishing Co., Ltd., 1999), and the contents thereof can be applied to the present invention. When a plastic substrate with poor heat resistance is used, it is preferable to conduct film formation at a low temperature of 150° C. or lower using ITO or IZO, to form a transparent anode.

<Cathode>

The cathode generally has a function as an electrode that injects electrons into an organic compound layer. The shape, structure, and size thereof are not particularly limited, and may be appropriately selected from known electrode materials in accordance with the use and purpose of the luminescent element.

The material constituting the cathode may be, for example, a metal, an alloy, a metal oxide, an electrically conductive compound, or a mixture thereof. Specific examples of the cathode material include alkali metals (e.g., Li, Na, K, Cs), alkali earth metals (e.g., Mg, Ca), gold, silver, lead, aluminum, a sodium-potassium alloy, a lithium-aluminum alloy, a magnesium-silver alloy, and rare earth metals such as indium and ytterbium. Only one of these materials may be used singly; however, it is preferable to use two or more of such materials in combination, from the viewpoint of obtaining a good balance of stability and electron injection ability.

Among them, as the material constituting the cathode, alkali metals and alkali earth metals are preferable in terms of electron injection ability, and a material whose main component is aluminum is preferable due to its superior storage stability.

The material whose main component is aluminum means aluminum itself, or an alloy or mixture of aluminum and 0.01 to 10 weight % of alkali metal or alkali earth metal (e.g., a lithium-aluminum alloy, a magnesium-aluminum alloy).

Materials for cathodes are described in detail in JP-A Nos. 2-15595 and 5-121172, and the materials described therein can be applied to the present invention.

Methods for forming the cathode are not particularly limited, and the cathode may be formed by known methods. The cathode may be formed by a method selected appropriately from, for example, the following in consideration of the compatibility with the material for constituting the cathode: wet systems such as printing systems and coating systems, physical systems such as vacuum deposition methods, sputtering methods, and ion plating methods, and chemical methods such as CVD and plasma CVD methods. For example, when a metal or the like is selected as the material of the cathode, the cathode may be formed by, for example, sputtering one material or sputtering two or more materials simultaneously or sequentially.

The patterning at the time of forming the cathode may be conducted by a chemical etching such as photolithography, or by a physical etching such as etching with a laser. The patterning may be effected by vacuum deposition, sputtering, or the like with a mask being superposed, or by a lift-off method or a printing method.

In the invention, the position at which the cathode is formed is not particularly limited. For example, the cathode may be formed on an entire surface of an organic compound layer, or on only a part of a surface of the organic compound layer.

A dielectric layer of a fluoride or oxide of an alkali metal or alkali earth metal with a thickness of from 0.1 nm to 5 nm may be inserted between the cathode and the organic compound layer. The dielectric layer may be considered to be a kind of electron injection layer. The dielectric layer can be formed by, for example, a vacuum deposition method, a sputtering method, or an ion plating method.

The thickness of the cathode may be adequately selected in accordance with the material constituting the cathode, and thus cannot be defined uniquely. The thickness of the cathode is generally from about 10 nm to about 5 μm, preferably from 50 nm to 1 μm.

The cathode may be transparent or opaque. A transparent cathode can be formed by forming a thin film of the cathode material to a thickness of from 1 nm to 10 nm, and further depositing a transparent conductive material such as ITO or IZO.

<Organic Compound Layer>

The organic compound layers in the invention will be described.

An organic electroluminescent element according to the invention includes one or more organic compound layers including a luminescent layer. Examples of organic compound layers other than the organic luminescent layer include a hole transport layer, an electron transport layer, a charge blocking layer, a hole injection layer, and an electron injection layer, as described above.

—Organic Luminescent Layer—The organic luminescent layer is a layer having the following functions at the time of voltage application: receiving holes from the anode, the hole injection layer, or the hole transport layer, receiving electrons from the cathode, the electron injection layer, or the electron transport layer, and providing a site for recombination of the holes and the electrons, thereby emitting light.

The luminescent layer in the invention may be constituted of only a luminescent material, or may be a mixture layer containing a host material and a luminescent material. The luminescent material may be a fluorescent luminescent material or a phosphorescent luminescent material, and may have only one dopant or two or more dopants. The host material is preferably a charge transport material. The luminescent layer may include only one host material or two or more host materials, for example a mixture of an electron transporting host material and a hole transporting host material. The luminescent layer may include a material that does not have electron transporting property and does not emit light.

The luminescent layer may include only one layer, or two or more layers, and the two or more layers may emit lights of respectively different colors.

Examples of fluorescent luminescent materials that can be used in the invention include: metal complexes such as metal complexes of benzoxazole derivatives, benzimidazole derivatives, benzothiazole derivatives, styrylbenzene derivatives, polyphenyl derivatives, diphenylbutadiene derivatives, tetraphenylbutadiene derivatives, naphthalimide derivatives, coumarin derivatives, condensed aromatic compounds, perinone derivatives, oxadiazole derivatives, oxazine derivatives, aldazine derivatives, pyralidine derivatives, cyclopentadiene derivatives, bisstyrylanthracene derivatives, quinacridone derivatives, pyrrolopyridine derivatives, thiadiazolopyridine derivatives, cyclopentadiene derivatives, styrylamine derivatives, diketopyrrolopyrrol derivatives, aromatic dimethylidine compounds, 8-quinolinol derivatives and pyrromethene derivatives; polymer compounds such as polythiophene, polyphenylene, and polyphenylenevinylene; and other compounds such as organic silane derivatives.

Examples of phosphorescence luminescent materials that can be used in the invention include complexes containing transition metal atoms or lanthanoid atoms.

The transition metal atoms are not particularly limited; ruthenium, rhodium, palladium, tungsten, rhenium, osmium, iridium, and platinum are preferable, and rhenium, iridium, and platinum are more preferable.

Examples of the lanthanoid atoms include lanthanum, cerium, praseodymium, neodymium, samarium, europium, gadolinium, terbium, dysprosium, holmium, erbium, thulium, ytterbium, and lutetium. Among these lanthanoid atoms, neodymium, europium, and gadolinium are preferable.

As ligands for the complex, the ligands described in the following literatures can be mentioned as examples: G Wilkinson et al., Comprehensive Coordination Chemistry (Pergamon Press, 1987), H. Yersin Photochemistry and Photographics of Coordination Compounds (Springer-Verlag, 1987), and Akio Yamamoto, Yuukikinnzoku kagaku-Kisotoouyou-(Organic metal chemistry-Fundamentals and Applications) (Shokabo Publishing Co., Ltd., 1982).

With respect to specific ligands, preferable ones include halogen ligands (preferably chlorine ligands), nitrogen-containing heterocyclic ligands (e.g., phenyl pyridine, benzoquinoline, quinolinol, bipyridyl, phenanthroline), diketone ligands (e.g., acetylacetone), carboxylic acid ligands (e.g., acetic acid ligands), carbon monooxide ligands, isonitrile ligands, and cyano ligands. More preferable ones include nitrogen-containing heterocyclic ligands. The complex may include only one transitional metal atom in the compound, or may be a multi-nuclear complex having two or more transitional metal atoms. For example, the complex may include different metal atoms simultaneously.

The phosphorescent luminescent material may be contained in the luminescent layer at a ratio of preferably, from 0.1 weight % to 40 weight %, more preferably from 0.5 weight % to 20 weight %.

The host material that may be contained in the luminescent layer in the invention may be selected from, for example, those having carbazole skeletons, those having diarylamine skeletons, those having pyridine skeletons, those having pyrazine skeletons, those having triazine skeletons, those having arylsilane skeletons, and those mentioned in the items for the hole injection layer, the hole transport layer, the electron injection layer, and the electron transport layer described below.

The thickness of the luminescent layer is not particularly limited, and a thickness of from 1 nm to 500 nm is usually preferable. The thickness is more preferably from 5 nm to 200 nm, and still more preferably from 10 nm to 100 nm.

In the invention, a white luminescent element having a high emission efficiency, a high luminance, and excellent chromaticity can be obtained by selecting a luminescent material appropriately. For example, a white luminescent element can be obtained by a combination of a blue luminescent material and an orange luminescent material that are luminescent materials of complementary colors, and a white luminescent element can be obtained by an appropriate selection of three of more different kinds of luminescent material such as a combination of a blue luminescent material, a green luminescent material, and a red luminescent material. In particular, the blue luminescent material is preferably a material whose maximum emission wavelength (wavelength at which emission intensity is maximum) is from 400 nm to 500 nm, more preferably from 420 nm to 490 nm, and particularly preferably from 430 nm to 470 nm. The green luminescent material preferably has a maximum emission wavelength of from 500 nm to 570 nm, more preferably from 500 nm to 560 nm, particularly preferably from 500 nm to 550 nm. The red luminescent material preferably has a maximum emission wavelength of from 580 nm to 670 nm, more preferably from 590 nm to 660 nm, and particularly preferably from 600 nm to 650 nm. White luminescent elements in which phosphorescent materials having high emission efficiency are used are disclosed in JP-A Nos. 2001-319780 and 2004-281087, Japanese Patent Application National Publication No. 2004-522276, and the like, and they can be used in the present invention.

The luminescent layer of the luminescent element according to the invention may include only one layer, or plural layers.

—Hole Injection Layer, Hole Transport Layer—

The hole injection layer or the hole transport layer is a layer having functions of receiving holes from the anode or from the anode side, and transporting the holes to the cathode side. The hole injection layer and the hole transport layer are each preferably a layer containing at least one selected from, for example, various metal complexes, and typical examples of the metal complexes include an Ir complex having a ligand such as a carbazole derivative, a triazole derivative, an oxazole derivative, an oxadiazole derivative, an imidazole derivative, a polyarylalkane derivative, a pyrazoline derivative, a pyrazolone derivative, a phenylenediamine derivative, an arylamine derivative, an amino-substituted chalcone derivative, a styrylanthracene derivative, a fluorenone derivative, a hydrazone derivative, a stilbene derivative, a silazane derivative, an aromatic tertiary amine compound, a styrylamine compound, an aromatic dimethylidine compound, a porphyrin compound, an organic silane derivative, carbon, phenylazole, or phenylazine.

The thicknesses of the hole injection layer and the hole transport layer are each preferably 500 nm or less from the viewpoint of lowering the driving voltage.

The thickness of the hole transport layer is preferably from 1 nm to 500 nm, more preferably from 5 nm to 200 nm, still more preferably from 10 nm to 200 nm. The thickness of the hole injection layer is preferably from 0.1 nm to 200 nm, more preferably from 0.5 nm to 200 nm, still more preferably 1 nm to 200 nm.

The hole injection layer and the hole transport layer each may have a monolayer structure containing one, or two or more, of the materials mentioned above, or each may have a multilayer structure having plural layers of the same composition or of different compositions.

—Electron Injection Layer, Electron Transport Layer—

The electron injection layer or the electron transport layer is a layer having functions of receiving electrons from the cathode or from the cathode side, and transporting the electrons to the anode side. The electron injection layer and the electron transport layer are each preferably a layer containing at least one of a metal complex, an organic silane derivative, and the like. The metal complex may be selected from various metal complexes, and typical examples thereof include a metal complex of a triazole derivative, an oxazole derivative, an oxadiazole derivative, an imidazole derivative, a fluorenone derivative, an anthraquinodimethane derivative, an anthrone derivatives, a diphenylquinone derivative, a thiopyran dioxide derivative, a carbodiimide derivative, a fluorenylidenemethane derivative, a distyrylpyrazine derivative, a tetracarboxylic acid anhydride having an aromatic ring such as naphthalene or perylene, a phthalocyanine derivative, or a 8-quinolinol derivative, a metal phthalocyanine, and a metal complex having a ligand such as benzoxazole or benzothiazole.

The thicknesses of the electron injection layer and the electron transport layer are each preferably 500 nm or less from the viewpoint of lowering the driving voltage.

The thickness of the electron transport layer is preferably from 1 nm to 500 nm, more preferably from 5 nm to 200 nm, still more preferably from 10 mm to 100 nm. The thickness of the electron injection layer is preferably from 0.1 nm to 200 nm, more preferably from 0.2 nm to 100 nm, still more preferably from 0.5 nm to 50 nm.

The electron injection layer and the electron transport layer each may have a monolayer structure containing one, or two or more, of the materials mentioned above, or each may have a multilayer structure having plural layers of the same composition or of different compositions.

—Hole Blocking Layer—

The hole blocking layer is a layer having a function of preventing the holes that have been transported from the anode side to the luminescent layer from passing through to the cathode side. In the present invention, the hole blocking layer may be provided as an organic compound layer that adjoins the luminescent layer at the cathode side of the luminescent layer.

Examples of organic compounds for constituting the hole blocking layer include aluminum complexes such as BAlq, triazole derivatives, and phenanthroline derivatives such as BCP.

The thickness of the hole blocking layer is preferably from 1 nm to 500 nm, more preferably from 5 nm to 200 nm, and still more preferably from 10 nm to 100 nm.

The hole blocking layer may have a monolayer structure containing one, or two or more, of the materials mentioned above, or each may have a multilayer structure having plural layers of the same composition or of different compositions.

—Formation of Organic Compound Layer—

In an organic electroluminescent element according to the invention, each of the organic compound layer(s) may be formed preferably by, for example, any of a dry-system film forming method such as a deposition method or a sputtering method, a transfer method, or a printing method.

In the organic electroluminescent element according to the invention, conventionally known means may be used as patterning methods.

<Protective Layer>

In the present invention, the entire organic EL element may be protected with a protective layer.

The material contained in the protective layer should have a function of preventing substances that accelerates deterioration of the element, such as moisture or oxygen, from entering the element.

Specific examples of the material include metals such as In, Sn, Pb, Au, Cu, Ag, Al, Ti, and Ni, metal oxides such as MgO, SiO, SiO₂, Al₂O₃, GeO, NiO, CaO, BaO, Fe₂O₃, Y₂O₃, and TiO₂, metal nitrides such as SiNₓ and SiNₓO_{y}, metal fluorides such as MgF₂, LiF, AlF₃, and CaF₂, polyethylene, polypropylene, polymethyl methacrylate, polyimide, polyurea, polytetrafluoroethylene, polychlorotrifluoroethylene, polydichlorodifluoroethylene, copolymers of chlorotrifluoroethylene and dichlorodifluoroethylene, copolymers obtained by copolymerization of a mixture of monomers including tetrafluoroethylene and at least one comonomer, fluorine-containing copolymers each having a cyclic structure in the copolymer main chain, water absorbing substances having a water absorption coefficient of 1% or more, and dampproof substances having a water absorption coefficient of 0.1% or less.

Methods for forming the protective layer are not particularly limited, and the following methods are applicable: a vacuum deposition method, a sputtering method, a reactive sputtering method, an MBE (molecular beam epitaxy) method, a cluster ion beam method, an ion plating method, a plasma polymerization method (radio-frequency exciting ion plating method), a plasma CVD method, a laser CVD method, a heat CVD method, a gas source CVD method, a coating method, a printing method, and a transfer method.

<Sealing>

Further, an entire organic electroluminescent element according to the invention may be sealed by using a sealing container.

Further disposed in the space between the sealing container and the luminescent element may be filled with a water absorbing agent or an inactive liquid. The water absorbing agent is not particularly limited, and examples thereof include barium oxide, sodium oxide, potassium oxide, calcium oxide, sodium sulfate, calcium sulfate, magnesium sulfate, phosphorous pentaoxide, calcium chloride, magnesium chloride, copper chloride, cesium fluoride, niobium fluoride, calcium bromide, vanadium bromide, molecular sieve, zeolite, and magnesium oxide. The inactive liquid is not particularly limited, and examples thereof include paraffins, liquid paraffins, fluorine-containing solvents such as perfluoroalkanes, perfluoroamines, and perfluoroethers, chlorine-containing solvents, and silicone oils.

An organic electroluminescent element according to the invention emits light when a DC voltage (usually from 2 to 15 volts and optionally containing an AC component as required) or a DC current is applied between the anode and the cathode.

Regarding methods for driving an organic electroluminescent element according to the invention, the driving methods described in, for example, JP-A Nos. 2-148687, 6-301355, 5-29080, 7-134558, 8-234685, and 8-241047, Japanese Patent No. 2784615, and U.S. Pat. Nos. 5,828,429 and 6,023,308 may be applied.

### 3. Color Filter

Each pixel in an organic EL display device according to the invention achieves a desired emission color through modification of an original emission color by a combination of a color filter and the original emission from the luminescent layer of the organic EL element.

In an exemplary embodiment, two or more kinds of pixel of different emission colors are provided on the same substrate, and at least one of the pixels is a pixel including a color filter that modifies the emission color. The two or more kinds of pixel having different emission colors are preferably composed of at least one red emitting pixel, at least one green emitting pixel, and at least one blue emitting pixel.

It is also preferable that the two or more kinds of pixel having different emission colors are composed of at least one white emitting pixel, at least one red emitting pixel, at least one green emitting pixel, and at least one blue emitting pixel. It is more preferable that the at least one red emitting pixel, the at least one green emitting pixel, and the at least one blue emitting pixel are each a pixel in which light from a white emitting pixel is modified by a color filter provided in the pixel.

In short, in embodiments of the invention, a luminescent layer is formed which contains at least one (i.e., one, or plural) luminescent material, so as to emit white light while maximizing the visible-light emitting area in the luminescent layer. Therefore, the luminescent layer is a white luminescent layer, and an arbitrary emission color can be extracted by combining the white luminescent layer and a color filter. Consequently, fine pixels emitting red, green, blue colors can be disposed at a high definition by disposing color filters to be combined at a high definition, without necessitating the arrangement of the luminescent layer at a high definition.

In the invention, the color filter may be disposed in any manner, and, for example, may be provided on a surface of the substrate, or between the substrate and a transparent electrode such as ITO. The emission color can be modified easily by using a color filter selected from color filters of different colors. When a white luminescent layer is used, color filters may be disposed at a high definition on a single luminescent element. However, use of the white luminescent layer is not essential to the invention. A desired emission color can be obtained by a combination of a luminescent material and a color filter. For example, in an exemplary embodiment of the invention, a desired color (e.g., red, green, or blue) may be reproduced by a combination of a color filter and a luminescent material that emits light in a color other than white.

An example of a pixel configuration of the invention when a white luminescent layer is used will now be described. A color filter layer in which three primary colors of red, green, and blue are combined is formed on a substrate. The color filter layer can be formed by a simple method such as a printing method. Then a transparent electrode is provided on the color filter layer, and at least one organic layer is provided on the entire area; therefore high-definition arrangement of organic layers with different emission colors is not required.

As described in JP-A No. 7-220871, a full color device can be produced as follows. An organic EL device is prepared which includes at least a hole transport layer and an electron transporting luminescent layer. In the luminescent layer, one colorant, or two or more colorants, is/are dispersed so as to maximize an area emitting visible light, and so as to emit white light. The organic EL device is further provided with a color filter so as to extract light of the desired color only, whereby a full color device can be produced.

For example, as described in JP-A No. 2004-311440, a constitution may be adopted in which a pixel electrode, a white luminescent layer, and a metal electrode are provided in this order on a substrate, wherein:

a red pixel is controlled such that the light emitted from the white luminescent layer passes through a red color filter layer provided between its driving TFT and its pixel electrode and such that only a red component of the light passes through the color filter;

a green pixel is controlled such that the light emitted from the white luminescent layer passes through a green color filter layer provided between its driving TFT and its pixel electrode and such that only a green component of the light passes through the color filter;

a blue pixel is controlled such that the light emitted from the white luminescent layer passes through a blue color filter layer provided between its driving TFT and its pixel electrode and such that only a blue component of the light passes through the color filter; and
a white pixel is controlled such that the light emitted from the white luminescent layer passes through a white color filter layer provided between its driving TFT and its pixel electrode and such that only a white component of the light passes through the color filter.

The dye or pigment to be used in the color filter layer preferably has a solubility, dispersibility, fluidity, and the like that are suitable for the method for providing the color filter (e.g., a coating method, a printing method), and appropriate spectral absorption characteristics as a filter. The dye or pigment may be selected from known materials.

In the following, a specific example of the constitution of an organic EL display device provided with a color filter layer is described by reference to figures. What is described below illustrates one example of preferred embodiments of the invention, and the invention is not limited thereto.

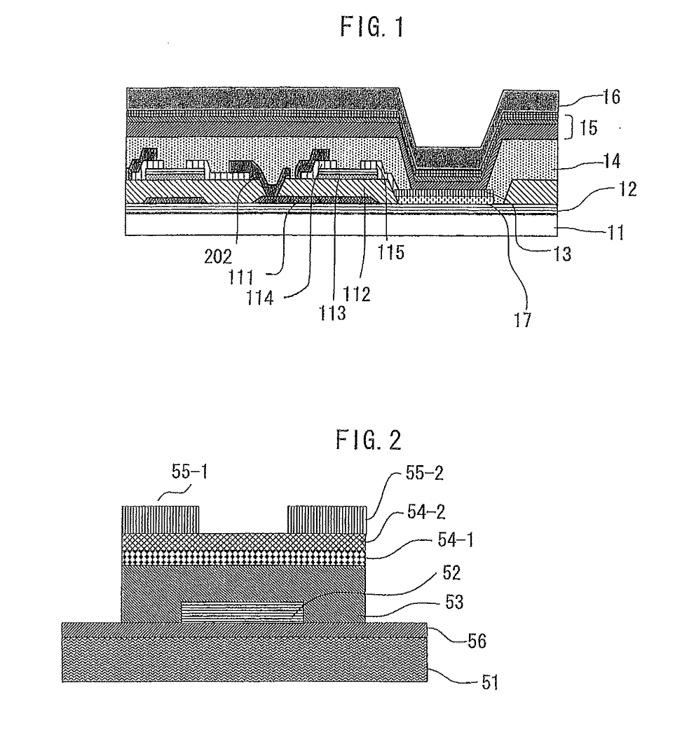

FIG. 1 shows an organic EL display device according to the invention. A substrate 11 is a flexible support such as a PEN film, and a substrate insulating layer 12 is provided thereon. A patterned color filter layer 17 is provided thereon. A gate electrode 111 is provided at a driving TFT portion and a gate insulating film 112 is provided at a TFT portion. A connection hole is provided at a part of the gate insulating film 112 so as to allow electrical connection. An active layer-resistive layer 113 according to the invention is provided at the driving TFT portion, and a source electrode 114 and a drain electrode 115 are provided thereon. The drain electrode 115 and a pixel electrode (anode) 13 of the organic EL element are continuous and integrated, are made of the same material, and are produced by the same process. The drain electrode of the switching TFT and the driving TFT are electrically connected by a connection electrode 202 at the connection hole. Further, the entire surface, excluding that portion of the pixel electrode at which the organic EL element is to be provided, is covered with an insulating film 14. On the pixel electrode portion, organic layers 15 including a luminescent layer and a cathode 16 are provided so as to form an organic EL element portion.

In an organic EL display device having a constitution shown in FIG. 1, the light emitted from the luminescent layer passes through the pixel electrode 13, modified by the color filter layer 17, passes through the substrate 11, and is taken out to the outside.

Although the constitution shown in FIG. 1 is a constitution of a bottom-emission element, a top-emission constitution is also possible in which the pixel electrode 13 is changed to a reflective electrode, the cathode 16 is a light-transmitting electrode, and a color filter is provided outside thereof.

(Applications)

Organic EL display devices according to the invention may be applied to a wide range of fields, including cell phone displays, personal digital assistants (PDA), computer displays, information displays to be mounted on automobiles, TV monitors, and general illumination.

The disclosure of Japanese Patent Application No. 2007-99516 is incorporated hereby reference in its entirety.

### EXAMPLES

In the following, an organic EL display device according to the invention is described by reference to Examples. However, the Examples should not be construed as limiting the invention.

### Example 1

### 1. Production of Organic EL Display Device

### 1) Formation of Gate Electrode (and Scanning Electric Wires)

After a 5 inch×5 inch glass substrate was washed, Mo was deposited to a thickness of 100 nm by sputtering. Then a photoresist was applied, a photomask was superposed thereon, and the photoresist was exposed through the photomask. Unexposed portions were cured by heating, and uncured photoresist was removed by a subsequent treatment with an alkaline developer. Thereafter treatment with an etching liquid was conducted to dissolve and remove that portion of the electrode region that was not covered with the cured photoresist. Finally, the photoresist was peeled off, thereby finishing the patterning process. As a result, a patterned gate electrode and patterned scanning electric wires were formed.

The treatment conditions at respective steps were as follows:

Sputtering condition for Mo: Sputtering was conducted by using a DC magnetron sputtering apparatus at a DC power of 380 W and a sputtering gas flow rate of Ar=12 sccm.

Photoresist coating condition: Photoresist OFPR-800 (manufactured by Tokyo Ohka Kogyo Co., Ltd.) was applied by spin coating at 4000 rpm for 50 sec.

Prebaking condition: 80° C., 20 min.

Exposure condition: 5 sec. (the g line of a ultra-high pressure mercury lamp, corresponding to 100 mJ/cm²)

Developing condition:
Developer NMD-3 (manufactured by Tokyo Ohka Kogyo Co., Ltd.):
   30 sec. (immersion)+30 sec. (agitation)
Rinsing: two cycles of (ultrasonic rinsing with pure water for 1 min.)
Postbaking: 120° C. for 30 min.
Etching condition:
   etching liquid was a mixed acid of nitric acid/phosphoric acid/acetic acid
Resist peeling condition: two cycles of (immersion in peeling liquid 104 (manufactured by Tokyo Ohka Kogyo Co., Ltd.) for 5 min.)
Washing: two cycles of (washing with IPA ultrasonic wave for 5 min.), and ultrasonic washing with water for 5 min.
Drying: blowing with N₂, and baking at 120° C. for 1 hour.

### 2) Formation of Gate Insulating Film

Subsequently, SiO₂ was sputtered to form a gate insulating film having a thickness of 200 nm.

Sputtering condition: sputtering was conducted by using an RF magnetron sputtering apparatus at an RF power of 400 W and a sputtering gas flow rate of Ar/O₂=12.0/2.0 sccm.

### 3) Formation of Active Layer and Resistive Layer

On the gate insulating film, a 10 nm-thick IGZO film (active layer) having a higher electrical conductivity and a 40 nm-thick IGZO film (resistive layer) having a lower electrical conductivity were sequentially provided by sputtering. Then patterning by a photoresist method was conducted to form an active layer and a resistive layer.

The sputtering conditions for the IGZO film having a higher electrical conductivity and the IGZO film having a lower electrical conductivity were as follows:

Sputtering conditions for the IGZO film having a higher electrical conductivity: sputtering was conducted on a polycrystalline sintered body having a composition of InGaZnO₄ as the target, by using an RF magnetron sputtering apparatus at a DC power of 200 W and a sputtering gas flow rate of Ar/O₂=12.0/0.6 sccm.

Sputtering conditions for the IGZO film having a lower electrical conductivity: sputtering was conducted on a polycrystalline sintered body having a composition of InGaZnO₄ as the target, by using an RF magnetron sputtering apparatus at a DC power of 200 W and a sputtering gas flow rate of Ar/O₂=12.0/1.6 sccm.

The patterning process by a photoresist method was the same as that employed for patterning the gate electrode, except that hydrochloric acid was used as the etching liquid.

4) Formation of Source and Drain electrodes and Pixel Electrode

After the formation of the active layer and the resistive layer, indium tin oxide (simply referred to as ITO) was sputtered to form a film having a thickness of 40 nm. Subsequently, a patterning process was conducted by a photoresist method similar to that employed for patterning the gate electrode, so that source and drain electrodes and a pixel electrode was provided.

ITO sputtering condition: sputtering was conducted by using an RF magnetron sputtering apparatus at a DC power of 40 W and a sputtering gas flow rate of Ar=12.0 sccm.

The patterning process by a photoresist method was the same as that employed for patterning the gate electrode, except that oxalic acid was used as the etching liquid.

### 5) Formation of Contact Hole

Subsequently, a patterning process by a photoresist method was conducted in a manner similar to that employed for patterning the gate electrode. Portions other than the portion at which a contact hole was to be formed were protected with a photoresist, and a hole was made in the gate insulating film by using a buffered hydrofluoric acid as the etching liquid, so that the gate electrode was exposed. Then the photoresist was removed in a manner similar to that employed for patterning the gate electrode, whereby a contact hole was formed.

### 6) Formation of Connection Electrode (and Common Electric Wires and Signal Electric Wires)

Subsequently, Mo was sputtered to form a film having a thickness of 200 nm.

sputtering condition for Mo: the same as the sputtering condition for the gate electrode forming step

Then a patterning process by a photoresist method was conducted in a manner similar to that employed for patterning the gate electrode, so that a connection electrode and common electric wires and signal electric wires were provided.

### 7) Formation of Insulating Film

Subsequently, a 2 μm-thick photosensitive polyimide film was applied, and patterned by a photoresist method to form an insulating film.

The coating and patterning conditions were as follows:

Coating condition: spin coating at 1000 rpm for 30 sec.

Exposure condition: 20 sec. (using the g line of a ultra-high pressure mercury lamp, at an energy corresponding to 400 mJ/cm²)

Developing condition:
Developer: NMD-3 (manufactured by Tokyo Ohka Kogyo Co., Ltd.) 1 min. (immersion)+1 min. (agitation)
Rinsing: ultrasonic washing with water, 1 min.×2+5 min.×1+blow with N₂
Postbaking: 120° C. for 1 hour.

Through the processes described above, a TFT substrate of an organic EL display device was produced.

### 8) Production of Organic EL Element

<Color Filter Layer>

Prior to forming the pixel electrode, the following color filter layer was provided in pattern at that position between the pixel electrode and the glass substrate in the organic EL element forming portion at which the pixel electrode was to be formed.

The photosensitive resin compositions for the individual colors were CR-2000 (for red color), CG-2000 (for green color), and CB-2000 (for blue color), all manufactured by FUJIFILM Electronics Materials Co., Ltd. (formerly Fuji Film Olin Co., Ltd.). First, the photosensitive resin composition for red color was applied by a spin coating method, and was pre-baked at 90° C. for 3 min.

After the pre-baking, the photosensitive resin composition was exposed through a photomask for forming a color filter, was developed by using a developer (tradename “CD”, manufactured by Fuji Film Olin Co., Ltd.), and was post-baked at 200° C. for 30 min. to form a red color filter layer at portions corresponding to the openings provided at predetermined positions. Similarly, a green color filter layer and a blue color filter layer were formed sequentially, using the compositions for green and blue, respectively. As a result, color filter layers in the three colors were formed.

<Organic Layer>

The following hole injection layer, hole transport layer, luminescent layer, hole blocking layer, electron transport layer, and electron injection layer were sequentially provided by a resistance heating vacuum deposition method.

<<Hole Injection Layer>>

On a TFT substrate which had been subjected to an oxygen plasma treatment, 4,4′,4″-tris(2-naphthylphenylamino)triphenylamine (simply referred to as 2-TNATA) was vapor-deposited to a thickness of 140 nm.

The oxygen plasma condition was as follows:

Oxygen plasma condition: O₂ flow rate=10 sccm, RF power=200 W, treatment time=1 min.

<<Hole Transport Layer>>

A 10 nm-thick layer of N,N′-dinaphthyl-N,N′-diphenyl-[1,1′-biphenyl]-4,4′-diamine (simply referred to as α-NPD).

<<Luminescent Layer: White Luminescent Material Layer>>

(First Luminescent Layer): A layer containing a mixture of 92 weight % of CBP and 8 weight % of FIrpic, in a thickness of 10 nm.
(Second Luminescent Layer): A layer containing a mixture of 92 weight % of CBP and 8 weight % of Btp₂Ir(acac), in a thickness of 10 nm.
(Third Luminescent Layer): A layer containing a mixture of 92 weight % CBP and 8 weight % of Ir(ppy)₃, in a thickness of 10 nm

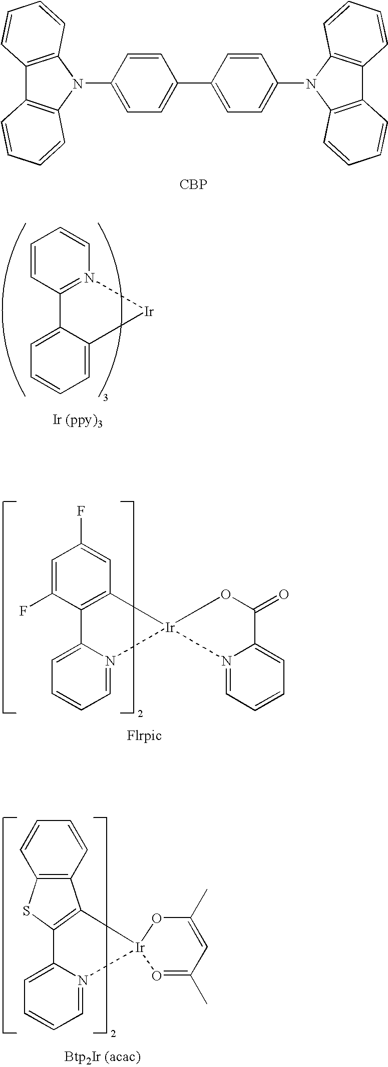

<<Hole Blocking Layer>>

A 10 nm-thick layer of bis-(2-methyl-8-quinonylphenolate)aluminum (simply referred to as BAlq).

### <<Electron Transport Layer>>

A 20 nm-thick layer of tris(8-hydroxyquinolinato)aluminum (simply referred to as Alq3).

### <<Electron Injection Layer>>

A 1 nm-thick layer of LiF.

<Formation of Cathode>

A 200 nm-thick cathode was provided by a resistance heating vacuum deposition method.

### 10) Sealing Process

On the TFT substrate having the organic EL element, a 2 μm-thick SiNₓ film as a sealing film was provided by plasma CVD (PECVD). Further, a protective film (PEN film having 50 nm-thick SiON deposited thereon) was adhered (90° C., 3 hours) onto the sealing film by using a thermosetting epoxy resin adhesive.

### 2. Performance of Organic EL Display Device

The organic EL display device produced by the processes described above exhibited a high definition emission (200 ppi) at a luminance of 300 cd/m² under application of a voltage of 7V.

### Example 2

An organic EL display device 2 was prepared in the same manner as in Example 1, except that the substrate size was changed to 15 inch×15 inch size.

The organic EL display device 2 was evaluated in the same manner as in Example 1, and a high definition emission (200 ppi) at a luminance of 300 cd/m² was obtained.

### Example 3

An organic EL display device 3 was prepared in the same manner as in Example 2, except that the glass substrate was replaced with a polyethylene naphthalate (PEN) film having a substrate insulating layer.

The organic EL display device 3 was evaluated in the same manner as in Example 1, and a high definition emission (200 ppi) at a luminance of 300 cd/m² was obtained.

1. An organic electroluminescent display device comprising at least a driving TFT and pixels which are formed by organic electroluminescent elements and are provided on a substrate of the TFT,
wherein the driving TFT includes at least a substrate, a gate electrode, a gate insulating film, an active layer, a source electrode, and a drain electrode; the driving TFT further includes a resistive layer between the active layer and at least one of the source electrode and the drain electrode; and the pixels include at least one color-modified pixel which has a color filter that modifies the emission color of the color-modified pixel, and which emits light of the modified color.

2. The organic electroluminescent display device according to claim 1, wherein the resistive layer has a lower electrical conductivity than that of the active layer.

3. The organic electroluminescent display device according to claim 1, wherein, in the at least one color-modified pixel, the color filter is provided at the side of the luminescent layer of the organic electroluminescent element from which light is extracted.

4. The organic electroluminescent display device according to claim 1, wherein the pixels include two or more kinds of pixel having respectively different emission colors, and at least one of the pixels is the at least one color-modified pixel.

5. The organic electroluminescent display device according to claim 4, wherein the two or more kinds of pixel having different emission colors include a red emitting pixel, a green emitting pixel, and a blue emitting pixel.

6. The organic electroluminescent display device according to claim 4, wherein the two or more kinds of pixel having respectively different emission colors include a white emitting pixel, a red emitting pixel, a green emitting pixel, and a blue emitting pixel.

7. The organic electroluminescent display device according to claim 6, wherein each of the red emitting pixel, the green emitting pixel, and the blue emitting pixel is a pixel in which the emission color of the white emitting pixel is modified by a color filter.

8. The organic electroluminescent display device according to claim 1, wherein the active layer is in contact with the gate insulating film, and the resistive layer is in contact with at least one of the source electrode and the drain electrode.

9. The organic electroluminescent display device according to claim 1, wherein the thickness of the layer of the resistive layer is greater than the thickness of the active layer.

10. The organic electroluminescent display device according to claim 1, wherein electrical conductivity continuously varies between the resistive layer and the active layer.

11. The organic electroluminescent display device according to claim 1, wherein the active layer and the resistive layer include oxide semiconductors, which may be the same or different.

12. The organic electroluminescent display device according to claim 11, wherein the oxide semiconductor is an amorphous oxide semiconductor.

13. The organic electroluminescent display device according to claim 11, wherein the oxygen concentration in the active layer is lower than the oxygen concentration in the resistive layer.

14. The organic electroluminescent display device according to claim 11, wherein the oxide semiconductor is at least one selected from the group consisting of oxides of In, Ga, and Zn, or a composite oxide thereof.

15. The organic electroluminescent display device according to claim 14, wherein the oxide semiconductor includes In and Zn, and the composition ratio of Zn to In in the resistive layer is higher than that in the active layer.

16. The organic electroluminescent display device according to claim 15, wherein the electrical conductivity of the active layer is 10⁻⁴ Scm⁻¹ or more but less than 10² Scm⁻¹.

17. The organic electroluminescent display device according to claim 1, wherein the ratio of the electrical conductivity of the active layer to the electrical conductivity of the resistive layer is from 10² to 10⁸.

18. The organic electroluminescent display device according to claim 17, wherein the substrate is a flexible resin substrate.
